(19) United States
(12) Patent Application Publication
(10) Pub. No.: US 2004/0013935 A1
(43) Pub. Date: Jan. 22, 2004

(54) Anode catalyst compositions for a voltage reversal tolerant fuel cell

(76) Inventors: Siyu Ye, Richmond (CA); Paul Beattie, Port Moody (CA); Stephen A. Campbell, Maple Ridge (CA); David P. Wilkinson, North Vancouver (CA); Brian Ronald Charles Theobald, Reading (GB); David Thompsett, Reading (CA)

Correspondence Address: MCANDREWS HELD & MALLOY, LTD, 500 WEST MADISON STREET, SUITE 3400, CHICAGO, IL, 60661

(21) Appl. No.: 10/198,795

(22) Filed: Jul. 19, 2002

(51) Int. Cl. H01M 4/92

(52) U.S. Cl. 429/44; 429/40

(57) ABSTRACT

In a solid polymer fuel cell series, various circumstances can result in a fuel cell being driven into voltage reversal. For instance, cell voltage reversal can occur if that cell receives an inadequate supply of fuel. In order to pass current, reactions other than fuel oxidation can take place at the fuel cell anode, including water electrolysis and oxidation of anode components. The latter can result in significant degradation of the anode, particularly if the anode employs a carbon black supported catalyst. Such fuel cells can be made substantially more tolerant to cell reversal by using certain anodes employing both a higher catalyst loading or coverage on a corrosion-resistant support and by incorporating, in addition to the typical electrocatalyst for promoting fuel oxidation, certain unsupported catalyst compositions to promote the water electrolysis reaction.

### FIELD OF THE INVENTION

The present invention relates to preferred catalyst compositions for anodes of solid polymer fuel cells and methods for rendering the fuel cells more tolerant to voltage reversal.

### BACKGROUND OF THE INVENTION

Fuel cell systems are currently being developed for use as power supplies in numerous applications, such as automobiles and stationary power plants. Such systems offer promise of economically delivering power with environmental and other benefits. To be commercially viable, however, fuel cell systems should exhibit adequate reliability in operation, even when the fuel cells are subjected to conditions outside the preferred operating range.

Fuel cells convert reactants, namely, fuel and oxidant, to generate electric power and reaction products. Fuel cells generally employ an electrolyte disposed between two electrodes, namely a cathode and an anode. A catalyst typically induces the desired electrochemical reactions at the electrodes.

Preferred fuel cell types include solid polymer electrolyte fuel cells that comprise a solid polymer electrolyte and operate at relatively low temperatures. A typical solid polymer electrolyte fuel cell comprises a cathode, an anode, a solid polymer electrolyte, an oxidant fluid stream directed to the cathode and a fuel fluid stream directed to the anode.

A broad range of reactants can be used in solid polymer electrolyte fuel cells. For example, the fuel stream can be substantially pure hydrogen gas, a gaseous hydrogen-containing reformate stream, or methanol in a direct methanol fuel cell. The oxidant can be, for example, substantially pure oxygen or a dilute oxygen stream such as air.

During normal operation of a solid polymer electrolyte fuel cell, fuel is electrochemically oxidized at the anode catalyst, typically resulting in the generation of protons, electrons, and possibly other species depending on the fuel employed. The protons are conducted from the reaction sites at which they are generated, through the electrolyte, to electrochemically react with the oxidant at the cathode catalyst. The catalysts are preferably located at the interfaces between each electrode and the adjacent electrolyte.

Solid polymer electrolyte fuel cells employ a membrane electrode assembly (“MEA”), which comprises the solid polymer electrolyte or ion-exchange membrane disposed between the two electrodes. Separator plates, or flow field plates for directing the reactants across one surface of each electrode substrate, are disposed on each side of the MEA.

Each electrode contains a catalyst layer, comprising an appropriate catalyst, located next to the solid polymer electrolyte. The catalyst can be a metal black, an alloy or a supported metal/alloy catalyst, for example, platinum supported on carbon black. Supported catalysts are often preferred as they can provide a relatively high catalyst surface to volume ratio and thus provide for a reduction in the cost of catalyst required. The catalyst layer typically contains ionomer which can be similar to that used for the solid polymer electrolyte (such as, for example, Nafion®). The catalyst layer can also contain a binder, such as polytetrafluoroethylene.

The electrodes can also contain a substrate (typically a porous electrically conductive sheet material) that can be employed for purposes of reactant distribution and/or mechanical support optionally, the electrodes can also contain a sublayer (typically containing an electrically conductive particulate material, for example, carbon black) between the catalyst layer and the substrate. A sublayer can be used to modify certain properties of the electrode (for example, interface resistance between the catalyst layer and the substrate, water management).

Electrodes for a MEA can be prepared by first applying a sublayer, if desired, to a suitable substrate, and then applying the catalyst layer onto the sublayer. These layers can be applied in the form of slurries or inks that contain particulates and dissolved solids mixed in a suitable liquid carrier. The liquid carrier is then evaporated off to leave a layer of particulates and dispersed solids. Cathode and anode electrodes can then be bonded to opposite sides of the membrane electrolyte via application of heat and/or pressure, or by other methods. Alternatively, catalyst layers can first be applied to the membrane electrolyte with optional sublayers and substrates incorporated thereafter (that is, a catalyzed membrane).

In operation, the output voltage of an individual fuel cell under load is generally below one volt. Therefore, in order to provide greater output voltage, numerous cells are usually stacked together and are connected in series to create a higher voltage fuel cell stack. (End plate assemblies are placed at each end of the stack to hold it together and to compress the stack components together. Compressive force effects adequate sealing and makes adequate electrical contact between various stack components.) Fuel cell stacks can then be further connected in series and/or parallel combinations to form larger arrays for delivering higher voltages and/or currents.

Electrochemical cells occasionally are subjected to a voltage reversal condition, which is a situation where the cell is forced to the opposite polarity. This can be deliberate, as in the case of certain electrochemical devices known as regenerative fuel cells. (Regenerative fuel cells are constructed to operate both as fuel cells and as electrolyzers in order to produce a supply of reactants for fuel cell operation. Such devices have the capability of directing a water fluid stream to an electrode where, upon passage of an electric current, oxygen is formed. Hydrogen is formed at the other electrode.) However, power-producing electrochemical fuel cells in series are potentially subject to unwanted voltage reversals, such as when one of the cells is forced to the opposite polarity by the other cells in the series. In fuel cell stacks, this can occur when a cell is unable to produce from the fuel cell reactions the current being forced through it by the rest of the cells. Groups of cells within a stack can also undergo voltage reversal and even entire stacks can be driven into voltage reversal by other stacks in an array. Aside from the loss of power associated with one or more cells going into voltage reversal, this situation poses reliability concerns. Undesirable electrochemical reactions can occur, which can detrimentally affect fuel cell components. Component degradation reduces the reliability and performance of the fuel cell, and in turn, its associated stack and array.

The adverse effects of voltage reversal can be prevented, for instance, by employing diodes capable of carrying the stack current across each individual fuel cell or by monitoring the voltage of each individual fuel cell and shutting down an affected stack if a low cell voltage is detected. However, given that stacks typically employ numerous fuel cells, such approaches can be quite complex and expensive to implement.

Alternatively, other conditions associated with voltage reversal can be monitored instead, and appropriate corrective action can be taken if reversal conditions are detected. For instance, a specially constructed sensor cell can be employed that is more sensitive than other fuel cells in the stack to certain conditions leading to voltage reversal (for example, fuel starvation of the stack). Thus, instead of monitoring every cell in a stack, only the sensor cell are monitored and used to prevent widespread cell voltage reversal under such conditions. However, other conditions leading to voltage reversal may exist that a sensor cell cannot detect (for example, a defective individual cell in the stack). Another approach is to employ exhaust gas monitors that detect voltage reversal by detecting the presence of or abnormal amounts of species in an exhaust gas of a fuel cell stack that originate from reactions that occur during reversal. While exhaust gas monitors can detect a reversal condition occurring within one or more cells in a stack and they may suggest the cause of reversal, such monitors do not identify specific problem cells and they do not generally provide warnings of an impending voltage reversal.

Instead of or in combination with the preceding, a passive approach may be preferred such that, in the event that reversal does occur, the fuel cells are either more tolerant to the reversal or are controlled in such a way that degradation of critical hardware is reduced. A passive approach may be particularly preferred if the conditions leading to reversal are temporary. If the cells can be made more tolerant to voltage reversal, it may not be necessary to detect for reversal and/or shut down the fuel cell system during a temporary reversal period. Thus, one method that has been identified for increasing tolerance to cell reversal is to employ a catalyst that is more resistant to oxidative corrosion than conventional catalysts (see International Publication No. WO 01/15254, published on Mar. 1, 2001, based upon International Application No. PCT/CA00/00968 filed on Aug. 23, 2000, entitled “Supported Catalysts for the Anode of a Voltage Reversal Tolerant Fuel Cell”).

A second method that has been identified for increasing tolerance to cell reversal is to incorporate an additional or second catalyst composition at the anode for purposes of electrolyzing water (see International Publication No. WO 01/15247, published on Mar. 1, 2001, based upon International Application No. PCT/CA00/00970 filed on Aug. 23, 2000, entitled “Fuel Cell Anode Structure for Voltage Reversal Tolerance”). During voltage reversal, electrochemical reactions can occur that result in the degradation of certain components in the affected fuel cell. Depending on the reason for the voltage reversal, there can be a rise in the absolute potential of the fuel cell anode. This can occur, for instance, when the reason is an inadequate supply of fuel (that is, fuel starvation). During such a reversal in a solid polymer fuel cell, water present at the anode can be electrolyzed and oxidation (corrosion) of the anode components, particularly carbonaceous catalyst supports if present, can occur. It is preferred to have water electrolysis occur rather than component oxidation. When water electrolysis reactions at the anode cannot consume the current forced through the cell, the rate of oxidation of the anode components increases, thereby tending to irreversibly degrade certain anode components at a greater rate. Thus, by incorporating a catalyst composition that promotes the electrolysis of water, more of the current forced through the cell can be consumed in the electrolysis of water than in the oxidation of anode components.

The '968 and '970 applications are hereby incorporated by reference herein in their entirety.

### SUMMARY OF THE INVENTION

In the present approach, unexpected benefits, in the form of radically greater tolerance to reversal, are obtained by employing an anode comprising a corrosion resistant first catalyst composition for evolving protons from the fuel and an unsupported second catalyst composition for evolving oxygen from water.

The first catalyst composition comprises a precious metal, and is typically selected from the group consisting of precious metals (platinum, palladium, rhodium, iridium, ruthenium, osmium, gold and silver), alloys of precious metals, and mixtures of precious metals. A preferred composition comprises an alloy of platinum and ruthenium in an atomic ratio of about 0.5-2 to 1, and particularly about 1:1. The first catalyst composition also comprises a support material that is at least as resistant to oxidative corrosion as Shawinigan acetylene black (from Chevron Chemical Company, Texas, USA).

The support is further protected from corrosion by increasing the loading of catalyst on the support, such that the loading of precious metal on the support is at least about 60% by weight. By increasing the loading of precious metal, a greater portion of the surface of the support is covered with catalyst and the relative perimeter of the exposed interface between catalyst and support is decreased (that is, the perimeter of the catalyst/support interface that is exposed per unit weight of catalyst).

The second catalyst composition comprises an unsupported precious metal oxide and is incorporated particularly for purposes of electrolyzing water at the anode during voltage reversal situations. Preferred compositions include a material selected from the group consisting of precious metal oxides, mixtures of precious metal oxides and solid solutions (that is, a homogeneous crystalline phase composed of several distinct chemical species, occupying the lattice points at random and existing in a range of concentrations) of precious metal oxides, particularly those in the group consisting of ruthenium oxide and iridium oxide. Particularly preferred are oxides characterized by the chemical formulae RuOₓ and IrOₓ, where x is greater than 1 and particularly about 2, and wherein the atomic ratio of ruthenium to iridium is greater than about 70:30, and particularly about 90:10. A preferred weight ratio of first catalyst composition to second catalyst composition is about 0.5-5 to 1, and particularly about 1.8 to 1.

### BRIEF DESCRIPTION OF THE DRAWINGS

FIG. 1 is a schematic diagram of a solid polymer fuel cell.

FIG. 2 shows a representative plot of voltage as a function of time, as well as representative plots of current consumed generating carbon dioxide and oxygen as a function of time, for a conventional solid polymer fuel cell undergoing fuel starvation.

FIG. 3 is a plot of voltage as a function of time for cells comprising Anodes A2 through A5 in the Examples during voltage reversal testing.

### DETAILED DESCRIPTION OF PREFERRED EMBODIMENT(S)

Voltage reversal occurs when a fuel cell in a series stack cannot generate the current provided by the rest of the cells in the series stack. Several conditions can lead to voltage reversal in a solid polymer fuel cell, including insufficient oxidant, insufficient fuel, insufficient water, low or high cell temperatures, and certain problems with cell components or construction. Reversal generally occurs when one or more cells experience a more extreme level of one of these conditions compared to other cells in the stack. While each of these conditions can result in negative fuel cell voltages, the mechanisms and consequences of such a reversal can differ depending on which condition caused the reversal.

During normal operation of a solid polymer fuel cell on hydrogen fuel, the following electrochemical reactions take place:

| | |
|---|---|
| At the anode: | H₂ → 2H⁺ + 2e⁻ |
| At the cathode: | ½O₂ + 2H⁺ + 2e⁻ → H₂O |
| Overall: | H₂ + e,fra 1/2O₂ → H₂O |

However, with insufficient oxidant (oxygen) present, the protons produced at the anode cross the electrolyte and combine with electrons directly at the cathode to produce hydrogen gas. The anode reaction and thus the anode potential remain unchanged. However, the absolute potential of the cathode drops and the reaction is:

At the cathode, in the absence of oxygen:

2H⁺+2e⁻→H₂

In this case, the fuel cell is operating like a hydrogen pump. Since the oxidation of hydrogen gas and the reduction of protons are both very facile (that is, small overpotential), the voltage across the fuel cell during this type of reversal is quite small. Hydrogen production actually begins at small positive cell voltages (for example, 0.03 V) because of the large hydrogen concentration difference present in the cell. The cell voltage observed during this type of reversal depends on several factors (including the current and cell construction) but, at current densities of about 0.5 A/cm², the fuel cell voltage can typically be greater than or about −0.1 V.

An insufficient oxidant condition can arise when there is water flooding in the cathode, oxidant supply problems, and the like. Such conditions then lead to low magnitude voltage reversals with hydrogen being produced at the cathode. Significant heat is also generated in the affected cell(s). These effects raise potential reliability concerns, however the low potential experienced at the cathode does not typically pose a significant corrosion problem for the cathode components. Nonetheless, some degradation of the membrane can occur from the lack of water production and from the heat generated during reversal. Also, the continued production of hydrogen can result in some damage to the cathode catalyst.

A different situation occurs when there is insufficient fuel present. In this case, the cathode reaction and thus the cathode potential remain unchanged. However, the anode potential rises to the potential for water electrolysis. Then, as long as water is available, some electrolysis takes place at the anode. However, the potential of the anode is then generally high enough to start significantly oxidizing typical components used in the anode, for example, the carbons employed as supports for the catalyst or the electrode substrate materials. Thus, some anode component oxidation typically occurs along with electrolysis. (Thermodynamically, oxidation of carbon components actually starts to occur before electrolysis. However, it has been found that electrolysis appears kinetically preferred and thus proceeds at a greater rate.) The reactions in the presence of oxidizable carbon-based components are typically:

At the anode, in the absence of fuel:

H₂O→½O₂+2H⁺+2e⁻

and

½C+H₂O→½CO₂+2H⁺+2e⁻

More current can be sustained by the electrolysis reaction if sufficient water is available at the anode catalyst layer. However, if not consumed in the electrolysis of water, current is instead used in the corrosion of the anode components. If the supply of water at the anode runs out, the anode potential rises further and the corrosion rate of the anode components increases. Thus, there is preferably an ample supply of water at the anode in order to prevent degradation of the anode components during reversal.

The voltage of a fuel cell experiencing fuel starvation is generally much lower than that of a fuel cell receiving insufficient oxidant. During reversal from fuel starvation, the cell voltage ranges around −1 V when most of the current is carried by water electrolysis. However, when electrolysis cannot sustain the current (for example, if the supply of water runs out or is inaccessible), the cell voltage can drop substantially (that is, much less than −1 V) and is theoretically limited only by the voltage of the remaining cells in the series stack. Current is then carried by corrosion reactions of the anode components or through electrical shorts that can develop as a result. Additionally, the cell can dry out, leading to very high ionic resistance and further heating. The impedance of the reversed cell can increase such that the cell is unable to carry the current provided by the other cells in the stack, thereby further reducing the output power provided by the stack.

Fuel starvation can arise when there is severe water flooding at the anode, fuel supply problems, and the like. Such conditions can then lead to high magnitude voltage reversals (that is, much less than −1 V) with oxygen being produced at the anode. Significant heat is again generated in the reversed cell. These effects raise more serious reliability concerns than an oxidant starvation condition. Very high potentials may be experienced at the anode thereby posing a serious anode corrosion and hence reliability concern.

Voltage reversals can also originate from low fuel cell temperatures, for example at start-up. Cell performance decreases at low temperatures for kinetic, cell resistance, and mass transport limitation reasons. Voltage reversal can then occur in a cell whose temperature is lower than the others due to a temperature gradient during start-up. Reversal can also occur in a cell because of impedance differences that are amplified at lower temperatures. However, when voltage reversal is due solely to such low temperature effects, the normal reactants are generally still present at both the anode and cathode (unless, for example, ice has formed so as to block the flowfields). In this case, voltage reversal is caused by an increase in overpotential only. The current forced through the reversed cell still drives the normal reactions to occur and thus the aforementioned corrosion issues arising from a reactant starvation condition are less of a concern. (However, with higher anode potentials, anode components can also be oxidized.) This type of reversal is primarily a performance issue that is resolved when the stack reaches a normal operating temperature.

Problems with certain cell components and/or construction can also lead to voltage reversals. For instance, a lack of catalyst on an electrode due to manufacturing error would render a cell incapable of providing normal output current. Similarly degradation of catalyst or another component for other reasons could render a cell incapable of providing normal output current.

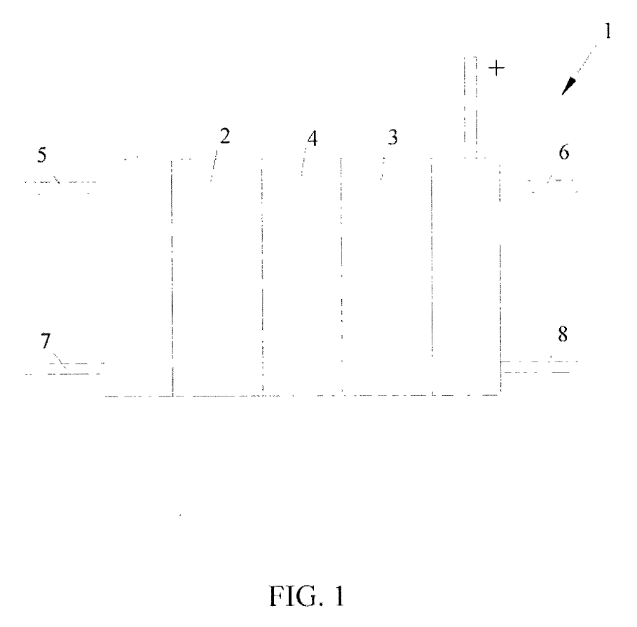

FIG. 1 shows a schematic diagram of a solid polymer fuel cell. Solid polymer fuel cell 1 comprises anode 2, cathode 3, and solid polymer electrolyte 4. The cathode typically employs catalyst supported on carbon powder that is mounted in turn upon a porous carbonaceous substrate. The anode here employs comprises a corrosion resistant first catalyst composition for evolving protons from the fuel and an unsupported second catalyst composition for evolving oxygen from water. A fuel stream is supplied at fuel inlet 5 and an oxidant stream is supplied at oxidant inlet 6. The reactant streams are exhausted at fuel and oxidant outlets 7 and 8 respectively. In the absence of fuel, water electrolysis and oxidation of carbon components or other oxidizable components in the anode can occur.

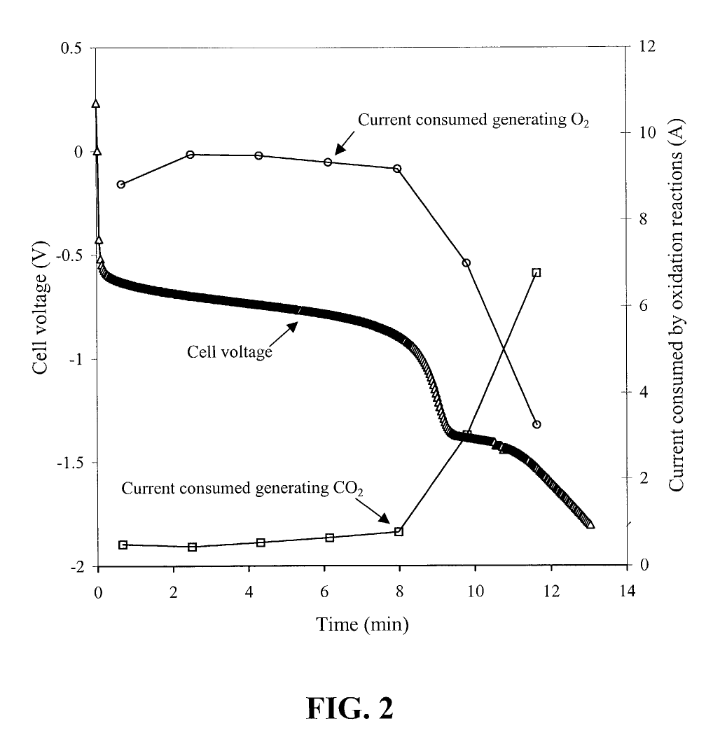

FIG. 2 shows a representative plot of voltage as a function of time for a conventional solid polymer fuel cell undergoing fuel starvation. (The fuel cell anode and cathode comprised carbon black-supported platinum/ruthenium and platinum catalysts respectively on carbon fiber paper substrates.) In this case, a stack reversal situation was simulated by using a constant current (10 A) power supply to drive current through the cell, and a fuel starvation condition was created by flowing humidified nitrogen (100% relative humidity (RH)) across the anode instead of the fuel stream. The exhaust gases at the fuel outlet of this conventional fuel cell were analyzed by gas chromatography during the simulated fuel starvation. The rates at which oxygen and carbon dioxide appeared in the anode exhaust were determined and used to calculate the current consumed in producing each gas also shown in FIG. 2.

As shown in FIG. 2, the cell quickly went into reversal and dropped to a voltage of about −0.6 V. The cell voltage was then roughly stable for about 8 minutes, with only a slight increase in overvoltage with time. During this period, most of the current was consumed in the generation of oxygen via electrolysis (H₂O→½O₂+2H⁺+2e⁻). A small amount of current was consumed in the generation of carbon dioxide (½C+H₂O→½CO₂+2H⁺+2e⁻). The electrolysis reaction thus sustained most of the reversal current during this period at a rough voltage plateau from about −0.6 V to about −0.9 V. At that point, it appeared that electrolysis could no longer sustain the current and the cell voltage dropped abruptly to about −1.4 V. Another voltage plateau developed briefly, lasting about 2 minutes. During this period, the amount of current consumed in the generation of carbon dioxide increased rapidly, while the amount of current consumed in the generation of oxygen decreased rapidly. On this second voltage plateau therefore, significantly more carbon was oxidized in the anode than on the first voltage plateau. After about 11 minutes, the cell voltage dropped off quickly again. Typically thereafter, the cell voltage continued to fall rapidly to very negative voltages (not shown) until an internal electrical short developed in the fuel cell (representing a complete cell failure). Herein, the inflection point at the end of the first voltage plateau is considered as indicating the end of the electrolysis period. The inflection point at the end of the second plateau is considered as indicating the point beyond which complete cell failure can be expected.

Without being bound by theory, the electrolysis reaction observed at cell voltages between about −0.6 V and about −0.9 V is presumed to occur because there is water present at the anode catalyst and the catalyst is electrochemically active. The end of the electrolysis plateau in FIG. 2 may indicate an exhaustion of water in the vicinity of the catalyst or loss of catalyst activity (for example, by loss of electrical contact to some extent). The reactions occurring at cell voltages of about −1.4 V would presumably require water to be present in the vicinity of anode carbon material without being in the vicinity of, or at least accessible to, active catalyst (otherwise electrolysis would be expected to occur instead). The internal shorts that develop after prolonged reversal to very negative voltages appear to stem from severe local heating which occurs inside the membrane electrode assembly, which can melt the polymer electrolyte, and create holes that allow the anode and cathode electrodes to touch.

In practice, a minor adverse effect on subsequent fuel cell performance can be expected after the cell has been driven into the electrolysis regime during voltage reversal (that is, driven onto the first voltage plateau). For instance, a 50 mV drop may be observed in subsequent output voltage at a given current for a fuel cell using carbon black-supported anode catalyst. More of an adverse effect on subsequent fuel cell performance (for example, 150 mV drop) will likely occur after the cell has been driven into reversal onto the second voltage plateau. Beyond that, complete cell failure can be expected as a result of internal shorting.

Other modifications can desirably be adopted to improve tolerance to voltage reversal. For instance, other component and/or structural modifications to the anode can be useful in providing and maintaining more water in the vicinity of the anode catalyst during voltage reversal. The use of an ionomer with a higher water content in the catalyst layer would be an example of a component modification that would result in more water in the vicinity of the anode catalyst.

The following examples illustrate certain embodiments and aspects of the invention. However, these examples should not be construed as limiting in any way.

### EXAMPLES

A series of solid polymer fuel cells was constructed in order to determine how reversal tolerance would be affected by employing a corrosion resistant anode catalyst in combination with the incorporation of a second catalyst composition at the anode for the purposes of electrolyzing water.

A series of anode catalyst compositions were prepared as outlined in the following Table:

TABLE 1

| Sam- | | |
|---|---|---|
| ple | First Catalyst Composition | Second Catalyst Composition |
| A1 | Pt/Ru alloy supported on | — |
| | Vulcan XC72R grade furnace | |
| | black (from Cabot Carbon Ltd., | |
| | South Wirral, UK), nominally | |
| | 20% Pt/10% Ru by weight | |
| A2 | Pt/Ru alloy supported on | RuO₂ supported on Shawinigan |
| | Shawinigan acetylene black, | acetylene black, nominally 20% |
| | nominally 20% Pt/10% Ru by | Ru (as oxide) by weight |
| | weight (the remainder being | (remainder carbon and oxygen) |
| | carbon) | |
| A3 | Pt/Ru alloy supported on | Unsupported RuO₂/IrO₂, |
| | Shawinigan acetylene black, | nominally a 90:10 atomic Ru/Ir |
| | nominally 20% Pt/10% Ru by | ratio |
| | weight | |
| A4 | Pt/Ru alloy supported on | — |
| | Shawinigan acetylene black, | |
| | nominally 40% Pt/20% Ru by | |
| | weight; | |
| A5 | Pt/Ru alloy supported on | Unsupported RuO₂/IrO₂, |
| | Shawinigan acetylene black, | nominally a 90:10 atomic Ru/Ir |
| | nominally 40% Pt/20% Ru by | ratio |
| | weight | |

Shawinigan acetylene black is more corrosion resistant support than Vulcan XC72R. This order of corrosion resistance is related to the graphitic nature of the carbon supports, in that the more graphitic the support, the more corrosion resistant the support. The graphitic nature of a carbon is exemplified by the carbon interlayer separation (d₀₀₂) determined through x-ray diffraction. Thus, carbons having smaller d₀₀₂ spacings may be suitable as more corrosion resistant supports. Synthetic graphite (essentially pure graphite) has a spacing of 3.36 Å compared with 3.50 Å for Shawinigan acetylene black and 3.64 Å for Vulcan XC72R, with the higher interlayer separations reflecting the decreasing graphitic nature of the carbon support and the decreasing order of corrosion resistance. Another indication of the corrosion resistance of the carbon supports is provided by the BET surface area measured using nitrogen. Vulcan XC72R has a surface area of about 228 m²/g. This contrasts with a surface area of about 80 m²/g for Shawinigan. The much lower surface area as a result of the graphitization process reflects a loss in the more corrodible microporosity in Vulcan XC72R. The microporosity is commonly defined as the surface area contained in the pores of a diameter less than 20 Å. The results of the BET analysis for Shawinigan acetylene black indicate a low level of corrodible microporosity available in that support.

To prepare the first catalyst compositions for the anodes, a conventional nominal 1:1 atomic ratio Pt/Ru alloy was deposited onto the indicated carbon support first. This was accomplished by making a slurry of the carbon black in demineralized water. Sodium bicarbonate was then added and the slurry was boiled for thirty minutes. A mixed solution comprising H₂PtCl₆ and RuCl₃ in an appropriate ratio was added while still boiling. The slurry was then cooled, formaldehyde solution was added, and the slurry was boiled again. The slurry was then filtered and the filter cake was washed with demineralized water on the filter bed until the filtrate was free of soluble chloride ions (as detected by a standard silver nitrate test). The filter cake was then oven dried at 105° C. in air, providing the nominally 20%/10% or 40%/20% Pt/Ru alloy carbon supported samples.

For Anode A2, a RuO₂ catalyst composition was formed onto uncatalyzed Shawinigan acetylene black. This was accomplished by making a slurry of the carbon black in boiling demineralized water. Potassium bicarbonate was added next and then RuCl₃ solution in an appropriate ratio while still boiling. The slurry was then cooled, filtered and filter cake washed with demineralized water as above until the filtrate was free of soluble chloride ions (as detected by a standard silver nitrate test). The filter cake was then oven dried at 105° C. in air until there was no further mass change. Finally, the sample was placed in a controlled atmosphere oven and heated for two hours at 350° C. under nitrogen. The RuO₂ sample was then admixed with a 20%/10% Pt/Ru alloy Shawinigan acetylene black supported sample.

For Anode A5, a mixed RuO₂/IrO₂ (90:10 atomic Ru/Ir ratio) unsupported catalyst was formed. This was accomplished by mixing ruthenium chloride and iridium chloride in the required ratio in dematerialized water. The solution was dried at 105° C. and the resulting residue converted to the mixed oxide by heating to 500° C. in air for 1 hour. A fine free-flowing powder was achieved by milling using a 0.8 mm sieve. The RuO₂/IrO₂ was then admixed with a 40%/20% Pt/Ru alloy Shawinigan black supported sample.

Cells were then prepared using the preceding anode catalyst compositions (Cell A1 through Cell A5). In the anodes, the catalyst compositions were applied in one or more separate layers in the form of aqueous inks on porous carbon substrates using a screen printing method. The aqueous inks comprised catalyst, ion conducting ionomer, and a binder. The catalyst loadings on the anodes were in the range of 0.1-0.3 mg Pt/cm². In Anodes A2, A3 and A5, the total oxide loadings were approximately 0.165 mg/cm². The MEAs (membrane electrode assemblies) for the cells employed a conventional cathode having as a catalyst platinum supported on Vulcan XC72R grade furnace black, nominally 40% platinum by weight, applied to a porous carbon substrate, and a conventional perfluorinated solid polymer membrane.

Each cell was conditioned prior to voltage reversal testing by operating it normally at a current density of 0.1 A/cm² and a temperature of approximately 75° C. Humidified hydrogen was used as fuel and humidified air as the oxidant, both at approximately 200 kPa pressure. The stoichiometry of the reactants (that is, the ratio of reactant supplied to reactant consumed in the generation of electricity) was 1.5 and 2 for the hydrogen and oxygen-containing air reactants, respectively.

All testing after the initial conditioning was done with the fuel and air supplied at 160 kPa pressure and at stoichiometries of 1.2 and 1.5, respectively. Before subjecting the cells to voltage reversal testing, the output cell voltage as a function of current density (polarization data) was determined using both humidified hydrogen and humidified reformate. The reformate comprised 65% hydrogen, 22% CO₂, 13% N₂, 40 parts per million (ppm) CO, saturated with water at 75° C., with an added 4% by volume air (the small amount of air being provided to counteract CO poisoning of the anode catalyst).

Each cell was then subjected to voltage reversal testing in three steps:

| | |
|---|---|
| Step 1: | 200 mA/cm² current was forced through each cell for 5 minutes |
| | while flowing humidified nitrogen (instead of fuel) over the |
| | anode. The cells were allowed to recover for 15 minutes at |
| | 1 A/cm² while operating on hydrogen and air. |
| Step 2: | The cells were subjected to 200 mA/cm² current pulses while |
| | operating on nitrogen and air. The pulse testing consisted of |
| | three sets of 30 pulses (10 seconds on/10 seconds off) with |
| | similar recovery periods (1 A/cm² while operating on hydrogen |
| | and air) for 15 minutes between sets and overnight after the last |
| | set of pulses. |
| Step 3: | 200 mA/cm² current was forced through the cells until −2 V was |
| | reached. The polarization tests were then repeated on the cells |
| | using both hydrogen and reformate fuel. |

Table 2 below summarizes the results of the polarization testing before and after steps 2 and 3 in the voltage reversal testing. In this Table, the voltages were determined at a current density of 0.8 A/cm².

V₀=voltage before reversal tests (mV)

ΔV₁=V₀—voltage after Step 2 (mV)

ΔV₂=V₀—voltage after Step 3 (mV)

TABLE 2

| | Reformate | | | Hydrogen | | | Time in reversal |
|---|---|---|---|---|---|---|---|
| | V₀ | ΔV₁ | ΔV₂ | V₀ | ΔV₁ | ΔV₂ | to reach −2 V |
| Anode | (mV) | (mV) | (mV) | (mV) | (mV) | (mV) | (minutes) |
| A1 | 721 | 163 | * | 756 | 151 | * | * |
| A2 | 740 | 46 | 148 | 769 | 18 | 115 | 14 |
| A3 | 719 | −6 | 204 | 760 | 5 | 208 | 74 |
| A4 | 748 | 9 | 43 | 772 | 5 | 29 | 167 |
| A5 | 730 | 6 | 44 | 772 | −4 | 27 | 1630 |

* Cell A1 reached −2 V during step 2 of voltage reversal testing at which point voltage reversal testing was halted and polarization data was obtained (that is, the cell did not proceed to step 3 of the voltage reversal testing).

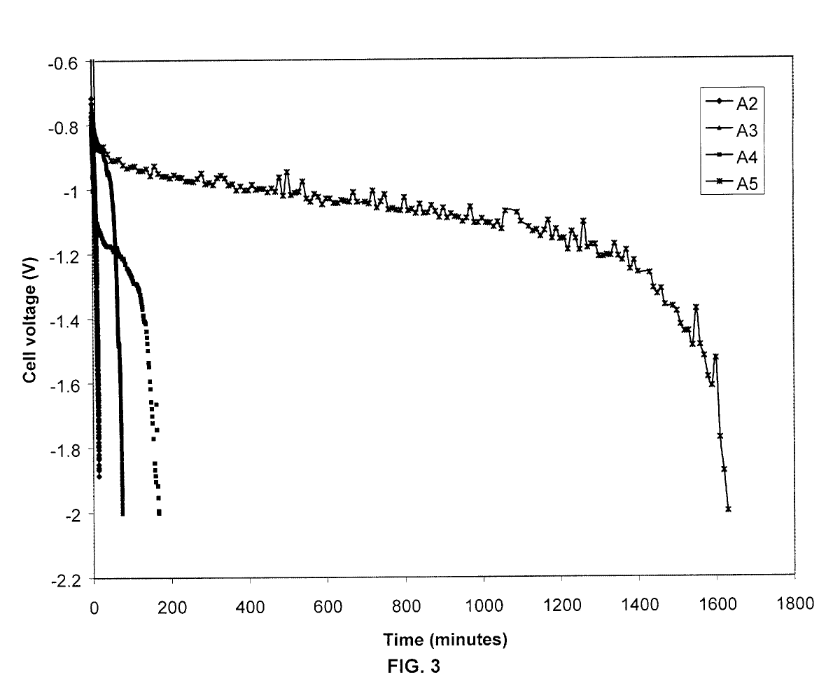

FIG. 3 shows the voltage versus time plots for Cells A2 through A5 during step 3 of the voltage reversal testing.

As shown in Table 2 and FIG. 3, Cells A2 and A3 (incorporating conventional carbon supported Pt/Ru catalyst plus a second catalyst composition for the electrolysis of water) showed improvement over Cell A1 in that they were able to reach step 3 of the voltage reversal testing. However, the cells degraded within 14 and 74 minutes respectively, and the change in voltage after step 3 (ΔV₂) were 148 mV and 204 mV, respectively. Cell A4 (incorporating a more corrosion resistant catalyst; that is, increased metal content on Shawinigan with the same platinum loading of the anode, but with no additional catalyst to promote water electrolysis) supported showed improvement over Cells A1 to A3, in that it took longer to reach −2V (167 minutes) and showed a smaller change in voltage after step 3 (ΔV₂=43 mV).

Cell A5 (incorporating both a more corrosion resistant catalyst and a second catalyst composition for the electrolysis of water) showed vastly improved tolerance to voltage reversal over all of the other cells. The cell was operated under extended reversal conditions for 1630 minutes with a ΔV₂ of only 44 mV. Thus, after being operated in reversal for nearly 10 times longer than Cell A4, ΔV₂ for Cell A5 was approximately the same as that of Cell A4.

As outlined in Table 2, comparable results for the hydrogen polarization tests were obtained.

The results demonstrate that by employing the catalyst composition in Anode A5, tolerance to voltage reversal was dramatically improved, far beyond what would be expected based on the results for either method alone. On the basis of this discovery, it is expected that if an even greater loading of precious metal in the first catalyst composition is employed (that is, greater than 60% by weight), or a support with even greater corrosion resistance is employed (that is, greater than that of Shawinigan), or both, voltage reversal tolerance of at least that observed for the catalyst composition employed in Anode A5 can be obtained. Accordingly, as the example demonstrates, voltage reversal tolerance is radically improved and unexpected benefits are obtained with the use of an anode having a higher loading of a first catalyst composition comprising platinum/ruthenium on a corrosion resistant support, admixed with a second unsupported component that promotes the electrolysis of water.

While the present anodes have been described for use in non-regenerative solid polymer electrolyte fuel cells, it is anticipated that they would be useful in other fuel cells as well. In this regard, “fuel cells” refers to fuel cells having operating temperatures below about 250° C. The present anodes are preferred for acid electrolyte fuel cells, which are fuel cells comprising a liquid or solid acid electrolyte, such as phosphoric acid, solid polymer electrolyte, and direct methanol fuel cells, for example. The present anodes are particularly preferred for solid polymer electrolyte fuel cells.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. An anode for use in a fuel cell having improved tolerance to voltage reversal, the anode comprising:
a first catalyst composition comprising a precious metal, wherein the precious metal is supported on a support which is at least as resistant to oxidative corrosion as Shawinigan acetylene black, and wherein the loading of the precious metal on the support is at least about 60% by weight; and
a second catalyst composition comprising an unsupported precious metal oxide.

2. The anode of claim 1 wherein the fuel cell is an acid electrolyte fuel cell.

3. The anode of claim 1 wherein the fuel cell is a solid polymer electrolyte fuel cell.

4. The anode of claim 1 wherein the precious metal comprises a precious metal containing compound selected from the group consisting of precious metals, alloys of precious metals, and mixtures of precious metals.

5. The anode of claim 1 wherein the precious metal comprises platinum.

6. The anode of claim 1 wherein the precious metal comprises an alloy of platinum and ruthenium.

7. The anode of claim 6 wherein the atomic ratio of platinum to ruthenium in the alloy is about 1:1.

8. The anode of claim 1 wherein the support is Shawinigan acetylene black.

9. The anode of claim 1 wherein the support comprises a graphitic carbon characterized by a d₀₀₂ spacing less than or equal to 3.50 Å.

10. The anode of claim 1 wherein the support comprises a graphitic carbon characterized by a BET surface area less than or equal to 80 m²/g.

11. The anode of claim 1 wherein the second catalyst composition is selected from the group consisting of precious metal oxides, mixtures of precious metal oxides and solid solutions of precious metal oxides.

12. The anode of claim 1 wherein the precious metal oxide is a solid solution of RuOₓ and IrOₓ, wherein x is greater than 1.

13. The anode of claim 1 wherein x is about 2.

14. The anode of claim 1 wherein the precious metal oxide comprises a solid solution of RuO₂ and IrO₂ and the atomic ratio of ruthenium to iridium is about 90:10.

15. The anode of claim 1 wherein the ratio of the first catalyst composition to the second catalyst composition by weight is about 1.8 to 1.

16. A membrane electrode assembly comprising the anode of claim 1.

17. A fuel cell comprising the anode of claim 1.

18. A non-regenerative fuel cell comprising the anode of claim 1.

19. A method of making a fuel cell more tolerant to voltage reversal, wherein the fuel cell comprises an anode, and the anode comprises:
a first catalyst composition comprising a precious metal, wherein the precious metal is supported on a support which is at least as resistant to oxidative corrosion as Shawinigan acetylene black, and wherein the loading of the precious metal on the support is at least about 60% by weight; and
a second catalyst composition comprising an unsupported precious metal oxide.

20. The method of claim 17 wherein the fuel cell is a solid polymer electrolyte fuel cell.

21. The method of claim 17 wherein the precious metal comprises a precious metal containing compound selected from the group consisting of precious metals, alloys of precious metals, and mixtures of precious metals.

22. The method of claim 1 wherein the precious metal comprises platinum.

23. The method of claim 17 wherein the precious metal comprises an alloy of platinum and ruthenium, wherein the atomic ratio of platinum to ruthenium in the alloy is about 1:1.

24. The method of claim 17 wherein the support is Shawinigan acetylene black.

25. The method of claim 17 wherein the support comprises a graphitic carbon characterized by a d₀₀₂ spacing less than or equal to 3.50 Å.

26. The method of claim 17 wherein the support comprises a graphitic carbon characterized by a BET surface area less than or equal to 80 m²/g.

27. The method of claim 17 wherein the second catalyst composition is selected from the group consisting of precious metal oxides, mixtures of precious metal oxides and solid solutions of precious metal oxides.

28. The method of claim 26 wherein the precious metal oxide is a solid solution of RuO₂ and IrO₂ and the atomic ratio of ruthenium to iridium is about 90:10.

29. The method of claim 1 wherein the ratio of the first catalyst composition to the second catalyst composition by weight is about 1.8 to 1.
